(19) United States
(12) Patent Application Publication
(10) Pub. No.: US 2013/0187912 A1
(43) Pub. Date: Jul. 25, 2013

(54) Three Dimensional (3D) Bounding Box with Hidden Edges

(71) Applicant: Eric J. Mueller, Los Gatos, CA (US)

(72) Inventor: Eric J. Mueller, Los Gatos, CA (US)

(73) Assignee: Motorola Mobility, Inc., Libertyville, IL (US)

(21) Appl. No.: 13/353,947

(22) Filed: Jan. 19, 2012

(51) Int. Cl. G06T 17/00

(52) U.S. Cl. 345/420

(57) ABSTRACT

In one embodiment, a method includes determining a set of elements rendered in a three dimensional (3D) space. Geometry information for the set of elements is determined based on a position and an orientation of each element of the set of elements in the 3D space. Then, bounding box coordinates for a bounding box are determined based on the geometry information. A viewing direction is determined that is being used to view the set of elements in 3D space. The method calculates at least one or more portions of edges of the bounding box that are determined to be not visible if viewed from the viewing direction in the 3D space and renders the bounding box in the 3D space with the at least one or more portions of edges hidden using the bounding box coordinates.

### BACKGROUND

Particular embodiments generally relate to three-dimensional (3D) authoring tools.

The orientation/placement of elements in 3D environment may be confusing to users because of the visual distortions caused by the projection of the elements into a 3D space. For example, a rectangle element with exactly the same dimensions as another rectangle element in a 3D space may appear larger or smaller than the other rectangle due to a distance from the viewpoint. When users are not used to working in a 3D space, it may be hard for the user to determine the position and orientation of the elements in the 3D space.

### SUMMARY

In one embodiment, a method includes determining a set of elements rendered in a three dimensional (3D) space. Geometry information for the set of elements is determined based on a position and an orientation of each element of the set of elements in the 3D space. Then, bounding box coordinates for a bounding box are determined based on the geometry information. A viewing direction is determined that is being used to view the set of elements in 3D space. The method calculates at least one or more portions of edges of the bounding box that are determined to be not visible if viewed from the viewing direction in the 3D space and renders the bounding box in the 3D space with the at least one or more portions of edges hidden using the bounding box coordinates.

In one embodiment, a non-transitory computer-readable storage medium is provided containing instructions for controlling a computer system to be operable to: determine a set of elements rendered in a three dimensional (3D) space; determine geometry information for the set of elements based on a position and an orientation of each element of the set of elements in the 3D space; determine bounding box coordinates for a bounding box based on the geometry information; determine a viewing direction that is being used to view the set of elements in 3D space; calculate at least one or more portions of edges of the bounding box that are determined to be not visible if viewed from the viewing direction in the 3D space; and render the bounding box in the 3D space with the at least one or more portions of edges hidden using the bounding box coordinates.

In one embodiment, an apparatus is provided comprising: one or more computer processors; and a computer-readable storage medium comprising instructions for controlling the one or more computer processors to be operable to: determine a set of elements rendered in a three dimensional (3D) space; determine geometry information for the set of elements based on a position and an orientation of each element of the set of elements in the 3D space; determine bounding box coordinates for a bounding box based on the geometry information; determine a viewing direction that is being used to view the set of elements in 3D space; calculate at least one or more portions of edges of the bounding box that are determined to be not visible if viewed from the viewing direction in the 3D space; and render the bounding box in the 3D space with the at least one or more portions of edges hidden using the bounding box coordinates.

The following detailed description and accompanying drawings provide a more detailed understanding of the nature and advantages of the present invention.

### BRIEF DESCRIPTION OF THE DRAWINGS

FIG. 1 depicts an example of a computing device for rendering 3D elements according to one embodiment.

FIG. 2 shows an example of an interface without a bounding box according to one embodiment.

FIG. 3 depicts an example of the interface with a bounding box according to one embodiment.

FIG. 4 depicts a simplified flowchart of a method for rendering the bounding box according to one embodiment.

FIG. 5 depicts an example of calculating portions of edges to hide according to one embodiment.

FIG. 6 shows the normal of each plane for the bounding box.

FIG. 7 shows an example of a document object model according to one embodiment.

FIG. 8 depicts a simplified flowchart of a method for processing a hierarchy of elements the DOM according to one embodiment.

### DETAILED DESCRIPTION

Described herein are techniques for a providing a bounding box in a 3D space. In the following description, for purposes of explanation, numerous examples and specific details are set forth in order to provide a thorough understanding of embodiments of the present invention. Particular embodiments as defined by the claims may include some or all of the features in these examples alone or in combination with other features described below, and may further include modifications and equivalents of the features and concepts described herein.

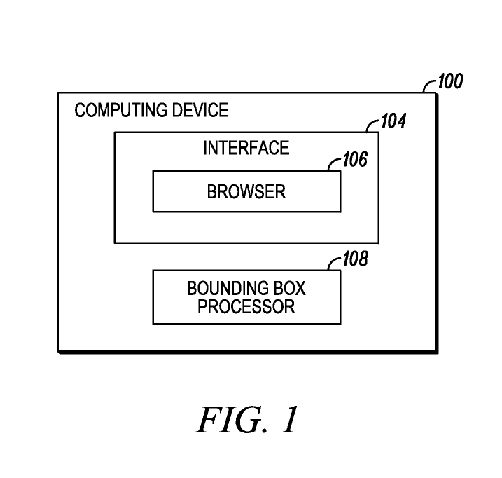

FIG. 1 depicts an example of a computing device 100 for rendering 3D elements according to one embodiment. Computing device 100 includes an interface 104 used to display 3D elements. In one embodiment, a browser 106 may be used to display the 3D elements. Browser 106 may be a software application that is used to display pages, such as web pages, based on a software code, such as hypertext transfer markup language (HTML) 5 or other languages that can be used to display pages in browser 106. In one embodiment, HTML5 is a universal software programming language that can be used across different computing platforms and environments. As will be discussed in more detail below, browser 106 treats individual elements as being in their own independent 3D space. Although browser 106 is discussed, particular embodiments may be used in other environments, such as proprietary 3D authoring tools.

A bounding box processor 108 generates and renders a 3D bounding box that visually encompasses 3D elements in the 3D space. The bounding box allows a user to discern the orientation and position of the 3D elements in the 3D space by giving users a visual reference in which to compare the position and orientation of 3D elements. In one example, the bounding box may include edges that are aligned to the X-Y-Z axes of the 3D space. The edges of the bounding box may also be aligned to positions other than the X-Y-Z axes. Particular embodiments calculate portions of edges or edges to hide based on a viewing direction. For example, as a viewing direction is changed when a user rotates the orientation of the 3D space (e.g., a user may rotate the 3D space to view the elements from a viewing position to the right), portions of edges or edges of the bounding box may be hidden. This shows how a bounding box would be viewed from the viewing direction if the box was solid. Hiding the edges gives a realistic view of the bounding box from the viewing direction. Accordingly, the bounding box allows a user to discern the position and orientation of the 3D elements by encompassing the 3D elements in a volume with visible edges and also hiding the edges that cannot be viewed based on the viewing direction.

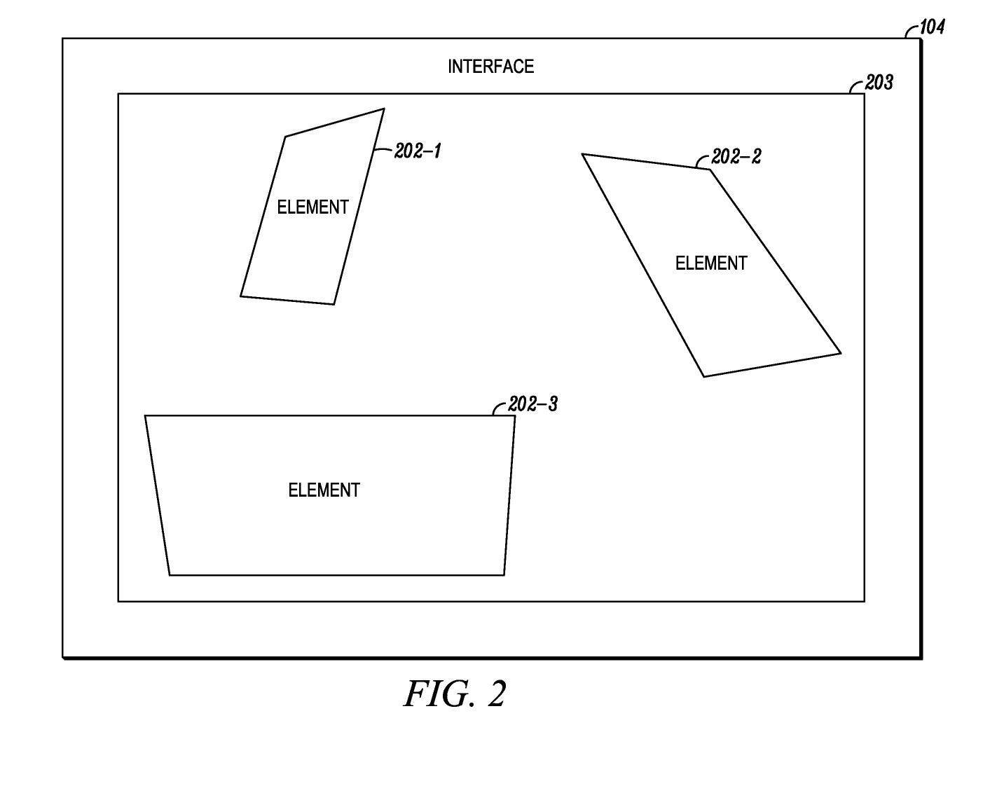

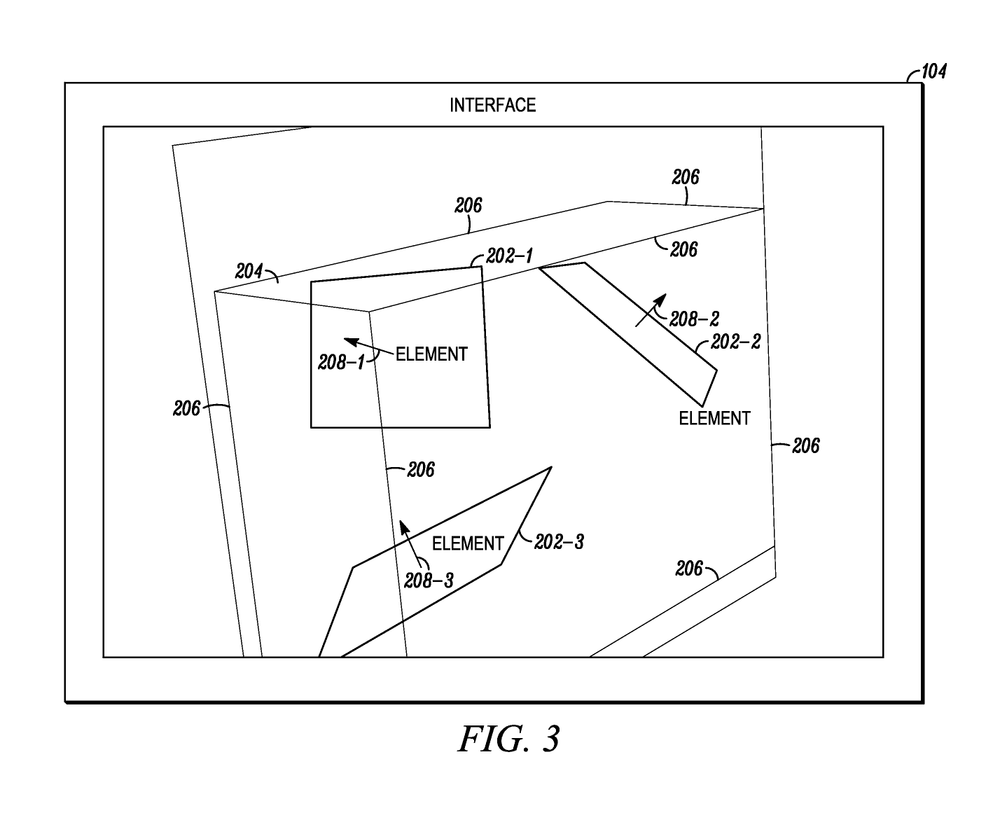

FIGS. 2-3 show examples of interface 104 for providing a bounding box according to one embodiment. FIG. 2 shows an example of interface 104 without a bounding box according to one embodiment. A plurality of elements 202-1-202-3 have been placed into the 3D space. Elements 202 have been placed in different orientations and positions in the 3D space. Elements 202 are also being viewed at a viewing direction. For example, the viewing direction may be viewing elements 202 in the negative Z direction. A selection 203 of elements 202-1-202-3 may be made to indicate that these elements 202-1-202-3 should be enclosed in a bounding box.

The user may change the viewing direction such that the 3D space is viewed from a different direction. Changing the viewing direction changes the way elements 202 are displayed in interface 104. For example, a user may wish to view the 3D space from a viewing position from the left where the viewing direction is in substantially the positive X direction. FIG. 3 depicts an example of interface 104 with a bounding box 204 according to one embodiment. Bounding box 204 includes a plurality of edges 206. Bounding box 204 encompasses elements 202 and is oriented with respect to the viewing direction. For example, bounding box 204 rotates as the viewing direction changes.

In FIG. 3, some edges 206 have been hidden. For example, edges 206 that would not appear to a user when viewing bounding box 204 from the viewing direction through user interface 104. For example, edges 206 that are behind planes of bounding box 204 are hidden. A normal 208 for each element 202 may also be displayed. Normal 208 for each element 202 may be used to help a user discern the position and orientation of element 202 in bounding box 204.

Edges 206 of bounding box 204 give the user a visual reference that helps discern the position and orientation of elements 202. Hidden edges 206 also help the user in determining from where the 3D space is being viewing. For example, the viewing direction can be determined looking at which edges 206 are hidden.

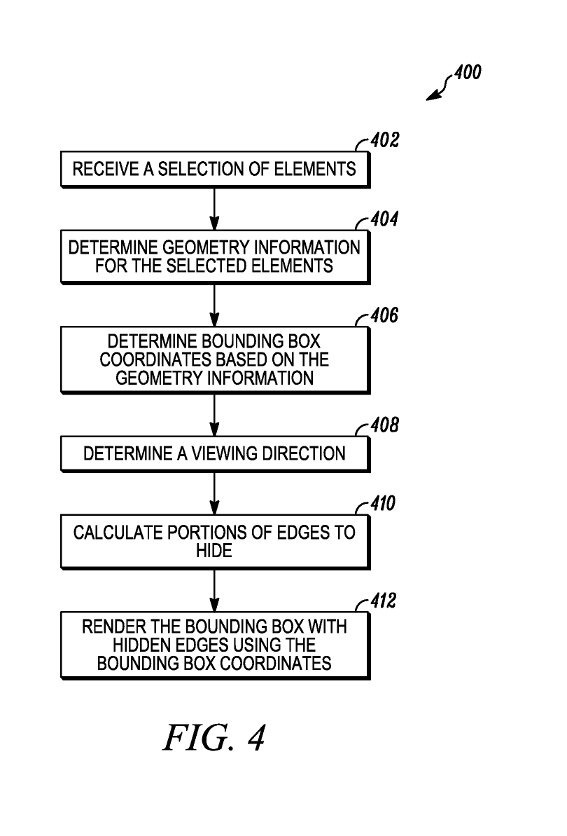

FIG. 4 depicts a simplified flowchart 400 of a method for rendering bounding box 204 according to one embodiment. At 402, bounding box processor 108 receives a selection of elements 202. For example, a user may select various elements 202 that have been rendered on interface 104.

At 404, bounding box processor 108 determines geometry information for the selected elements 202. For example, as will be described in more detail below, each element 202 when placed in the 3D space is transformed and projected when rendered in browser 106. Geometry information for each of the transformed and projected elements 202 is determined

At 406, bounding box processor 108 determines bounding box coordinates based on the geometry information. For example, the bounding box coordinates are determined such that bounding box 204 encloses all of selected elements 202. For example, bounding box coordinates in the X-Y-Z directions are determined for bounding box 204. The geometry for the selected elements 202 are analyzed to determine maximum coordinates in each of the X, Y, and Z direction for the geometry. The bounding box coordinates may be at least the maximum coordinates, or possibly larger, such that all of the selected elements 202 are encompassed.

At 408, bounding box processor 108 determines a viewing direction. The viewing direction is the direction in which the 3D space is being viewed from. At 410, bounding box processor 108 calculates edges 206 to hide. For example, edges 206 that are determined to be not viewable from the viewing direction in interface 104 are hidden. In one example, entire edges 206 may be hidden and/or portions of edges 206 are hidden. At 412, bounding box processor 108 then renders bounding box 204 in the 3D space with the hidden edges 206 using the bounding box coordinates.

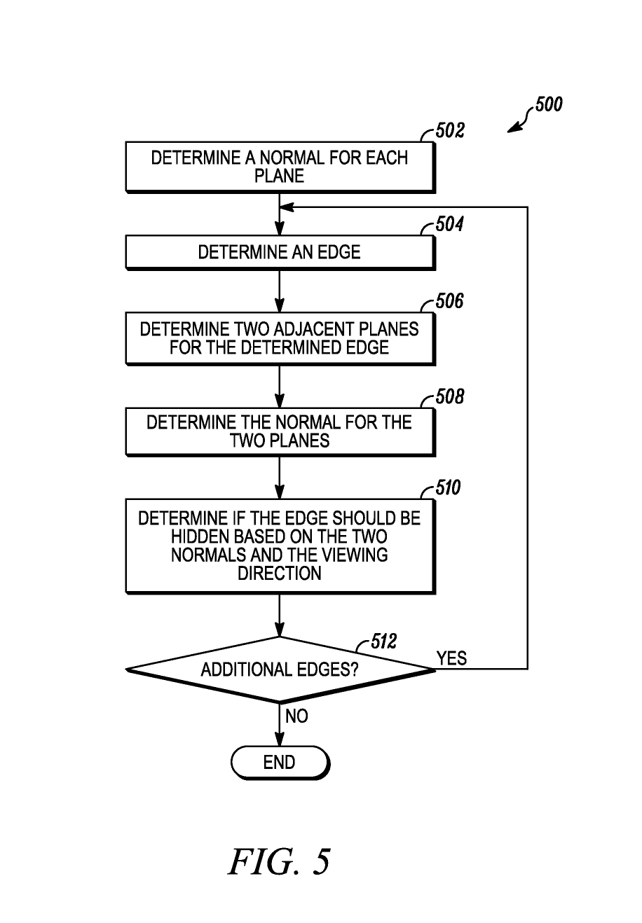

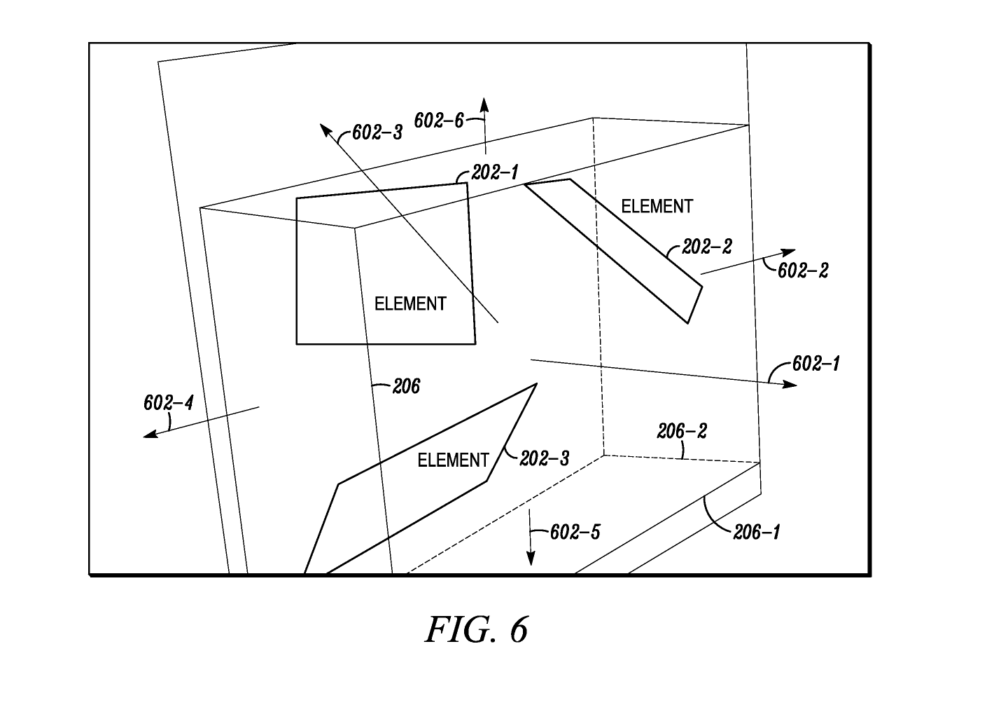

FIG. 5 depicts an example of flowchart 500 for calculating portions of edges 206 to hide according to one embodiment. At 502, bounding box processor 108 determines a normal to each plane of bounding box 204. For example, FIG. 6 shows a normal 602 of each plane for bounding box 204. A normal 602-1 is the normal for a front plane; a normal 602-2 is the normal for a right plane; a normal 602-3 is the normal for a back plane; a normal 602-4 is the normal for a left plane; a normal 602-5 is the normal for a bottom plane; and a normal 602-6 is the normal for a top plane.

At 504, bounding box processor 108 determines an edge 206. For example, each edge 206 of bounding box 204 is analyzed. At 506, bounding box processor 108 determines two adjacent planes for the determined edge 206. For example, for an edge 206-1, the front plane and the bottom plane are determined At 508, bounding box processor 108 determines the normal 602 for each of the planes. For example, normal 602-1 and normal 602-5 are determined for the right plane and the bottom plane, respectively.

At 510, bounding box processor 108 determines if edge 206 should be hidden. It is also possible that a portion of edge 206 is hidden in some embodiments. In one example, if both normal 602 for the two adjacent planes are determined to be facing the viewing direction, then edge 206 is hidden. That is, both normal are facing away from a user that is viewing interface 104. If one normal 602 is not facing the viewing direction, then edge 206 is drawn. That is, if one or both normals 602 are facing the user through interface 104, edge 206 is drawn.

In one example, a calculation is performed to determine if edge 206 should be hidden. A normal is determined to be facing the viewing direction if the angle between the viewing direction and the normal of an adjacent plane is less than 90 degrees. If the angle is greater than 90 degrees, the normal is not facing the viewing direction. The viewing direction shown in FIG. 6 is substantially in between the negative Z and the positive X direction. For edge 206-1, the adjacent planes are plane 206-1 and 206-5. Normal 602-1 is between the positive X direction and positive Z, and normal 602-5 is in the negative Y direction. Normal 602-1 is greater than 90 degrees from the viewing direction and normal 602-5 is 90 degrees from the viewing direction. Both normals 602-1 and 602-5 are not within 90 degrees of the viewing direction, and are thus edge 206-1 is not hidden. Although 90 degrees is described, a threshold of another value may be used to determine if edge 206 is hidden.

For a hidden edge 206-2, the right plane and the bottom plane are adjacent planes to edge 206-2. Hidden edge 206-2 is shown with dotted lines for discussion purposes. Normal 602-2 is in between the positive X direction and the negative Z direction and normal 602-5 is in the negative Y direction. It is determined that normal 602-2 is within 90 degrees of the viewing direction. Normal 602-5 is neutral in that it is halfway between the viewing direction and the user viewing interface 104 (e.g., 90 degrees from the viewing direction. The neutral normal 602-5 means hiding edge 206-2 depends on the orientation of normal 602-2, which is less than 90 degrees from the viewing direction. Thus, edge 206-2 is hidden.

At 512, bounding box processor 108 determines if additional edges 206 need to be analyzed. If so, the process reiterates to 502. If not, the process ends.

In one embodiment, elements 202 may be displayed in browser 106. Browser 106 is a platform independent application that can be used to display 3D elements 202. However, the browser 106 treats individual 3D elements 202 as being in independent 3D spaces. Each 3D element 202 may be independently transformed and projected in each element's 202 own 3D space.

Browser 106 may be different from proprietary three-dimensional (3D) authoring tools that allow users to place elements 202 into a single 3D environment. For example, when the user creates an element in the proprietary 3D authoring tool, the element can be placed into a 3D space with other 3D elements without any transform and/or projection operations. This is because the proprietary 3D authoring tool works in a single 3D space. The proprietary 3D authoring tools allow a user to create elements in the 3D space without any transformation and projection; however, the tool is proprietary and thus the design is not portable to other platforms. For example, if the user wants to display a created page in a different platform, the code for the page is not portable to the other platform.

Including bounding box 204 and calculating where to place bounding box 204 in a proprietary authoring tool may be provided without transforming and projecting the placed 3D elements because the 3D elements are automatically placed in the same 3D space as bounding box 204. However, even though the user can use bounding box 204, the user is restricted in using the proprietary authoring tool.

To calculate where to draw bounding box 204 and where to hide edges 206 in browser 106, each individual element 202 is transformed and projected to a unified 3D space. For example, a document object model (DOM) may be used to specify a hierarchy of elements 202 to be included in a page to render in browser 106. Browser 106 treats each element of the DOM as being in its own individual 3D space. Calculating where to place bounding box 204 and which edges 206 to hide cannot be performed when the elements 202 are in their own 3D space. Accordingly, bounding box processor 108 transforms and projects elements of the DOM into a unified 3D space in which bounding box 204 will be drawn. In one example, the unified 3D space is a global screen space that is pixels on the screen with depth where the 3D elements 202 and bounding box 204 will be displayed on browser 106. In one embodiment, each element 202 in the hierarchy of the DOM is transformed and projected at each level. This process will be described in more detail below. Elements 202 in the unified 3D space have geometry information that defines the positions and orientations relative to each other in the unified 3D space. Bounding box processor 108 is then used to determine where to place and hide edges 206 of bounding box 204 based on the geometry of the 3D elements in the unified 3D space.

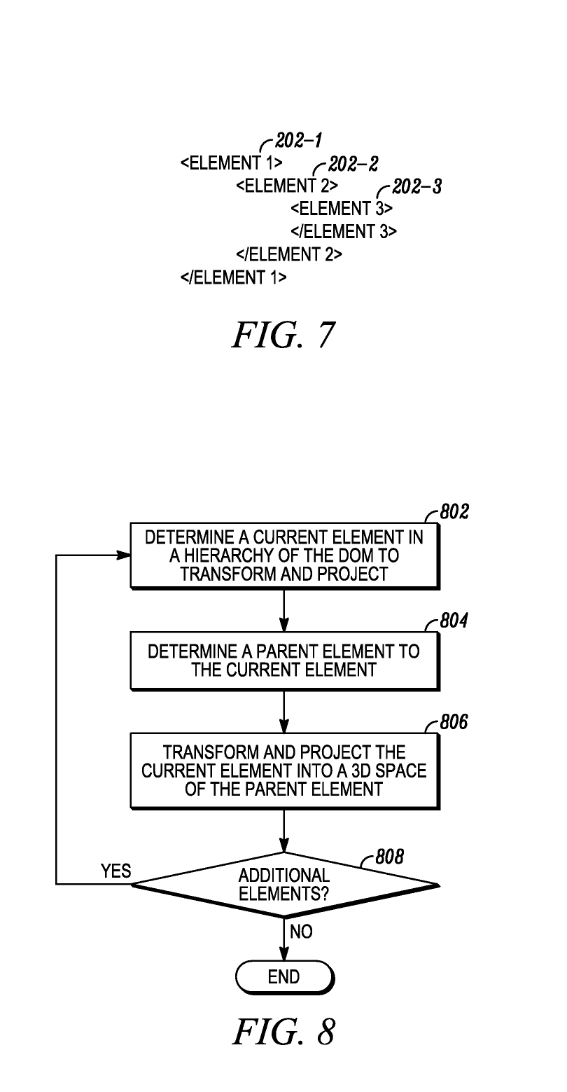

As mentioned above, the document object model may include a plurality of elements 202 and describes elements 202 that are to be included in and displayed in browser 106. The document object model may be a cross platform language for representing elements 202 to be displayed in browser 106. FIG. 7 shows an example of a document object model according to one embodiment. Elements 202 are included in a hierarchical structure. For example, element 202-3 is a child element of element 202-2. Additionally, element 202-2 is a child of element 202-1. Any number of elements may be nested in the hierarchy.

The processing of the DOM shown in FIG. 7 will be described with respect to FIG. 8, which depicts a simplified flowchart 800 of a method for processing a hierarchy of elements the DOM according to one embodiment.

At 802, bounding box processor 108 determines a current element in a hierarchy of the DOM to transform and project. For example, at the beginning of the process, a first element 202 of the DOM is processed. As will be described in more detail below, each element 202 in the hierarchy is transformed and projected.

At 804, bounding box processor 108 determines a parent element 202 to the current element 202. For example, if element 202-3 is first determined as the current element 202, then element 202-2 is determined as the parent element 202.

At 806, bounding box processor 108 transforms and projects the current element into a 3D space of the parent element 202. For example, a 3D transform of element 202-3 is performed and the perspective is applied in the parent 3D space. A person of skill in the art will appreciate how to perform a 3D transform and apply the perspective for element 202-3 into the parent 3D space.

At 808, bounding box processor 108 determines if additional elements 202 need to be processed in the hierarchy. For example, the entire hierarchy may be traversed to transform and project lower level elements 202 into a higher level 3D space. In one example, element 202-3 has been transformed and projected into the 3D space of element 202-2. Then, elements 202-3 and 202-2 are transformed and projected into a 3D space of element 202-1. If this is the case, then the process reiterates to 802 where the current element is determined to be element 202-2. At 804, bounding box processor 108 determines a parent element, which is element 302-1. At 806, bounding box processor 108 transforms and projects elements 202-2 and 202-3 into the 3D space of element 202-1. In this case, element is 202-1 is a root element, and thus no more transforms are needed. After transform and projection at each level of the hierarchy, elements 202-1, 202-2, and 202-3 have thus been transformed and projected into a unified 3D space and a transform and projection is performed at each level of the hierarchy. The final transform and projection of each element 202 in the hierarchy is the concatenation of the transforms and projections of all of the element's parents in the hierarchy.

When no more elements exist, the process ends. The above process may be repeated at each level of the hierarchy; however, not every level of the hierarchy needs to be transformed and projected.

After transforming and projecting, the hierarchy of elements in the DOM into the unified 3D space in which bounding box 204 will be drawn, calculations for hiding edges 206 of bounding box 204 can also be performed.

Accordingly, a bounding box 204 is provided that gives a user a visual cue to the relationship between selected elements 202. A user may see the orientation and position of elements 202 with respect to each other when enclosed in bounding box 204. Edges 206 of bounding box 204 are hidden to show the viewing direction to the user.

Particular embodiments may be implemented in a non-transitory computer-readable storage medium for use by or in connection with the instruction execution system, apparatus, system, or machine. The computer-readable storage medium contains instructions for controlling a computer system to perform a method described by particular embodiments. The instructions, when executed by one or more computer processors, may be operable to perform that which is described in particular embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents may be employed without departing from the scope of the invention as defined by the claims.

What is claimed is:

1. A method comprising:
determining a set of elements rendered in a three dimensional (3D) space;
determining geometry information for the set of elements based on a position and an orientation of each element of the set of elements in the 3D space;
determining bounding box coordinates for a bounding box based on the geometry information;
determining a viewing direction that is being used to view the set of elements in 3D space;
calculating, by a computing device, at least one or more portions of edges of the bounding box that are determined to be not visible if viewed from the viewing direction in the 3D space; and
rendering the bounding box in the 3D space with the at least one or more portions of edges hidden using the bounding box coordinates.

2. The method of claim 1, wherein calculating the at least one or more portions of edges that are determined to be not visible comprises:
determining a normal to each plane of the bounding box; and
determining which edges or portions of the edges are not visible based on the normal for each plane.

3. The method of claim 2, wherein determining which portions of the edges are not visible comprises:
selecting an edge of the bounding box;
determining a first adjacent plane and a second adjacent plane to the selected edge;
determining a first normal for the first adjacent plane and a second normal for the second adjacent plane; and
comparing the first normal and the second normal to the viewing direction to determine if at least a portion of the selected edge should be hidden.

4. The method of claim 2, wherein comparing comprises:
determining if both the first normal and the second normal are determined to be facing the viewing direction;
hiding the edge if both the first normal and the second normal are determined to be facing the viewing direction; and
not hiding the edge if one of the first normal and the second normal are determined to not be facing the viewing direction.

5. The method of claim 1, further comprising:
detecting movement of the viewing direction in the 3D space; and
re-calculating the one or more portions of edges to hide based on the movement of the viewing direction.

6. The method of claim 1, wherein the bounding box encompasses the set of elements.

7. The method of claim 1, wherein the 3D space is displayed in a browser, wherein the browser is configured to treat individual elements as having independent 3D spaces in the browser.

8. The method of claim 7, further comprising transforming and projecting each of the set of elements into a 3D space in the browser in which edges of the bounding box will be drawn.

9. The method of claim 8, further comprising:
determining a hierarchical structure of elements including an element in the set of elements;
traversing the hierarchical structure to transform and project the element into a 3D space associated with a next element in the hierarchical structure; and
continuing to perform the traversing where lower level elements are transformed and projected into a 3D space associated with a higher level next element in the hierarchical structure, wherein the traversing is performed until each element of the hierarchical structure is transformed and projected into the 3D space.

10. A non-transitory computer-readable storage medium containing instructions for controlling a computer system to be operable to:
determine a set of elements rendered in a three dimensional (3D) space;
determine geometry information for the set of elements based on a position and an orientation of each element of the set of elements in the 3D space;
determine bounding box coordinates for a bounding box based on the geometry information;
determine a viewing direction that is being used to view the set of elements in 3D space;
calculate at least one or more portions of edges of the bounding box that are determined to be not visible if viewed from the viewing direction in the 3D space; and
render the bounding box in the 3D space with the at least one or more portions of edges hidden using the bounding box coordinates.

11. The non-transitory computer-readable storage medium of claim 10, wherein calculate the at least one or more portions of edges that are determined to be not visible comprises:
determine a normal to each plane of the bounding box; and
determine which edges or portions of the edges are not visible based on the normal for each plane.

12. The non-transitory computer-readable storage medium of claim 11, wherein determine which portions of the edges are not visible comprises:
select an edge of the bounding box;
determine a first adjacent plane and a second adjacent plane to the selected edge;
determine a first normal for the first adjacent plane and a second normal for the second adjacent plane; and
compare the first normal and the second normal to the viewing direction to determine if at least a portion of the selected edge should be hidden.

13. The non-transitory computer-readable storage medium of claim 11, wherein compare comprises:
determine if both the first normal and the second normal are determined to be facing the viewing direction;
hide the edge if both the first normal and the second normal are determined to be facing the viewing direction; and
not hide the edge if one of the first normal and the second normal are determined to not be facing the viewing direction.

14. The non-transitory computer-readable storage medium of claim 10, further operable to:
detect movement of the viewing direction in the 3D space; and
re-calculate the one or more portions of edges to hide based on the movement of the viewing direction.

15. The non-transitory computer-readable storage medium of claim 10, wherein the bounding box encompasses the set of elements.

16. The non-transitory computer-readable storage medium of claim 10, wherein the 3D space is displayed in a browser, wherein the browser is configured to treat individual elements as having independent 3D spaces in the browser.

17. The non-transitory computer-readable storage medium of claim 16, further operable to transform and project each of the set of elements into a 3D space in the browser in which edges of the bounding box will be drawn.

18. The non-transitory computer-readable storage medium of claim 16, further operable to:
determine a hierarchical structure of elements including an element in the set of elements;
traverse the hierarchical structure to transform and project the element into a 3D space associated with a next element in the hierarchical structure; and
continue to perform the traversing where lower level elements are transformed and projected into a 3D space associated with a higher level next element in the hierarchical structure, wherein the traverse is performed until each element of the hierarchical structure is transformed and projected into the 3D space.

19. An apparatus comprising:
one or more computer processors; and
a computer-readable storage medium comprising instructions for controlling the one or more computer processors to be operable to:
determine a set of elements rendered in a three dimensional (3D) space;
determine geometry information for the set of elements based on a position and an orientation of each element of the set of elements in the 3D space;
determine bounding box coordinates for a bounding box based on the geometry information;
determine a viewing direction that is being used to view the set of elements in 3D space;
calculate at least one or more portions of edges of the bounding box that are determined to be not visible if viewed from the viewing direction in the 3D space; and
render the bounding box in the 3D space with the at least one or more portions of edges hidden using the bounding box coordinates.

20. The apparatus of claim 19, wherein calculate the at least one or more portions of edges that are determined to be not visible comprises:
determine a normal to each plane of the bounding box; and
determine which edges or portions of the edges are not visible based on the normal for each plane.
